(19) United States
(12) Patent Application Publication
(10) Pub. No.: US 2015/0315969 A1
(43) Pub. Date: Nov. 5, 2015

(54) FUEL SUPPLY SYSTEM

(71) Applicant: General Electric Company, Schenectady, NY (US)

(72) Inventors: Mark Jason Fisher, Simpsonville, SC (US); Douglas Scott Byrd, Greer, SC (US); Alberto Jose Negroni, Simpsonville, SC (US); Carlos Gabriel Roman, Simpsonville, SC (US)

(73) Assignee: General Electric Company, Schenectady, NY (US)

(21) Appl. No.: 14/268,696

(22) Filed: May 2, 2014

(51) Int. Cl. F02C 7/22

(52) U.S. Cl. CPC F02C 7/222

(57) ABSTRACT

A fuel supply system includes a main fuel line path configured to route a fuel to a combustion inlet region and a secondary fuel line path fluidly coupled to the main fuel line path. The secondary fuel line path is configured to divert a portion of the fuel from the main fuel line path through a first segment of the secondary fuel line path and return the fuel to the main fuel line path through a second segment of the secondary fuel line path. An obstruction mechanism is located proximate the main fuel line path at an obstruction location and is configured to cyclically translate into the main fuel line path to cyclically alter a cross-sectional area of the main fuel line path to effectively oscillate fuel flow pressure into a combustion system.

### BACKGROUND OF THE INVENTION

The subject matter disclosed herein relates to fuel supply systems and, more particularly, to a fuel supply system configured to route fuel to a combustion assembly of a gas turbine engine.

In a gas turbine engine, air is pressurized in a compressor and mixed with fuel in a combustor for generating hot combustion gases that flow downstream through turbine stages where energy is extracted. Large industrial power generation gas turbine engines typically include a plurality of combustor cans within which combustion gases are separately generated and collectively discharged.

Of particular concern to effective operation of can combustor engines is combustion dynamics (i.e., dynamic instabilities in operation). High dynamics are often caused by fluctuations in conditions such as the temperature of the exhaust gases (i.e., heat release) and oscillating pressure levels within a combustor can. Such high dynamics can limit hardware life and/or system operability of an engine, causing such problems as mechanical and thermal fatigue. Combustor hardware damage can come about in the form of mechanical problems relating to fuel nozzles, liners, transition pieces, transition piece sides, radial seals, and impingement sleeves, for example.

Various attempts to control combustion dynamics have been made in an effort to prevent degradation of system performance. Such efforts include, for example, reducing dynamics by decoupling the pressure and heat release oscillations (e.g., by changing the flame shape, location, etc. to control heat release within a combustion engine) or “de-phasing” the pressure and heat release. A resonator is one component that has been employed to achieve such dynamics reductions. However, increasing power output requirements results in a smaller window of combustion operability since matching of combustion and turbine frequencies is to be avoided.

### BRIEF DESCRIPTION OF THE INVENTION

According to one aspect of the invention, a fuel supply system includes a main fuel line path configured to route a fuel to a combustion inlet region. Also included is a secondary fuel line path fluidly coupled to the main fuel line path and configured to divert a portion of the fuel from the main fuel line path through a first segment of the secondary fuel line path and return the fuel to the main fuel line path through a second segment of the secondary fuel line path. Further included is an obstruction mechanism located proximate the main fuel line path at an obstruction location, the obstruction mechanism configured to cyclically translate into the main fuel line path to cyclically alter a cross-sectional area of the main fuel line path.

According to another aspect of the invention, a fuel supply system includes a main fuel line path configured to route a fuel to a combustion inlet region. Also included is a secondary fuel line path fluidly coupled to the main fuel line path, the secondary fuel line path having a fluid chamber, the fluid chamber having an inlet and an outlet. Further included is a piston disposed within the fluid chamber and cyclically translatable between a first position and a second position. Yet further included is an obstruction member disposed within an orifice extending between the fluid chamber and the main fuel line path, the obstruction member operatively coupled to the piston and moveable into the main fuel line path in response to translation of the piston, wherein the first position of the piston provides a first cross-sectional area of the main fuel line path and the second position of the piston provides a second cross-sectional area of the main fuel line path that is less than the first cross-sectional area. Also included is a first segment of the secondary fuel line path routing fuel from the main fuel line path to the inlet of the fluid chamber. Further included is a second segment of the secondary fuel line path routing fuel from the outlet of the fluid chamber to the main fuel line path at a location downstream from the first segment.

According to yet another aspect of the invention, a gas turbine system includes a compressor, a combustion assembly having at least one combustion chamber, and a turbine section. Also included is a fuel supply system configured to route fuel to the combustion assembly. The fuel supply system includes a main fuel line path configured to route a fuel to a combustion inlet region. The fuel supply system also includes a secondary fuel line path fluidly coupled to the main fuel line path and configured to divert a portion of the fuel from the main fuel line path through a first segment of the secondary fuel line path and return the fuel to the main fuel line path through a second segment of the secondary fuel line path. The fuel supply system further includes an obstruction mechanism located proximate the main fuel line path at an obstruction location, the obstruction mechanism configured to cyclically translate into the main fuel line path to cyclically alter a cross-sectional area of the main fuel line path.

These and other advantages and features will become more apparent from the following description taken in conjunction with the drawings.

### BRIEF DESCRIPTION OF THE DRAWINGS

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which:

FIG. 1 is a schematic illustration of a gas turbine engine;

FIG. 2 is a schematic illustration of a fuel supply system for delivering fuel to the gas turbine engine, the fuel supply system in a first condition;

FIG. 3 is a schematic illustration of the fuel supply system in a second condition; and

FIG. 4 illustrates a plurality of intervals of oscillation of fuel mass flow of the fuel supply system.

The detailed description explains embodiments of the invention, together with advantages and features, by way of example with reference to the drawings.

### DETAILED DESCRIPTION OF THE INVENTION

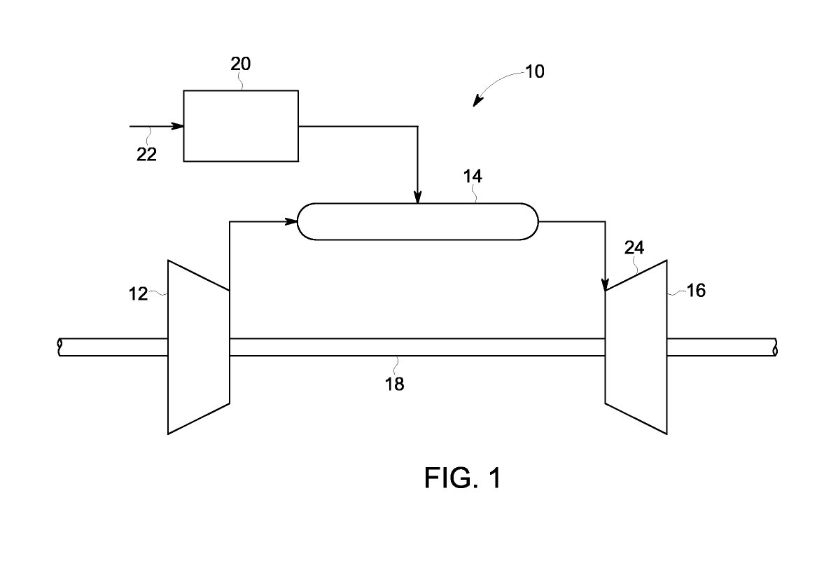

Referring to FIG. 1, a gas turbine engine 10, constructed in accordance with an exemplary embodiment of the invention, is schematically illustrated. The gas turbine engine 10 includes a compressor section 12, a combustion assembly 14, a turbine section 16, a shaft 18 and a fuel supply system 20. It is to be appreciated that one embodiment of the gas turbine engine 10 may include a plurality of compressor sections 12, combustion assemblies 14, turbine sections 16, and/or shafts 18. The compressor section 12 and the turbine section 16 are coupled by the shaft 18. The shaft 18 may be a single shaft or a plurality of shaft segments coupled together to form the shaft 18.

In operation, air flows into the compressor section 12 and is compressed into a high pressure gas. The high pressure gas is supplied to the combustion assembly 14 and mixed with a fuel 22, for example process gas and/or synthetic gas (syngas). Alternatively, the combustion assembly 14 can combust fuels that include, but are not limited to natural gas and/or fuel oil. The fuel/air or combustible mixture is ignited to form a high pressure, high temperature combustion gas stream. Thereafter, the combustion assembly 14 channels the combustion gas stream to the turbine section 16, which converts thermal energy to mechanical, rotational energy.

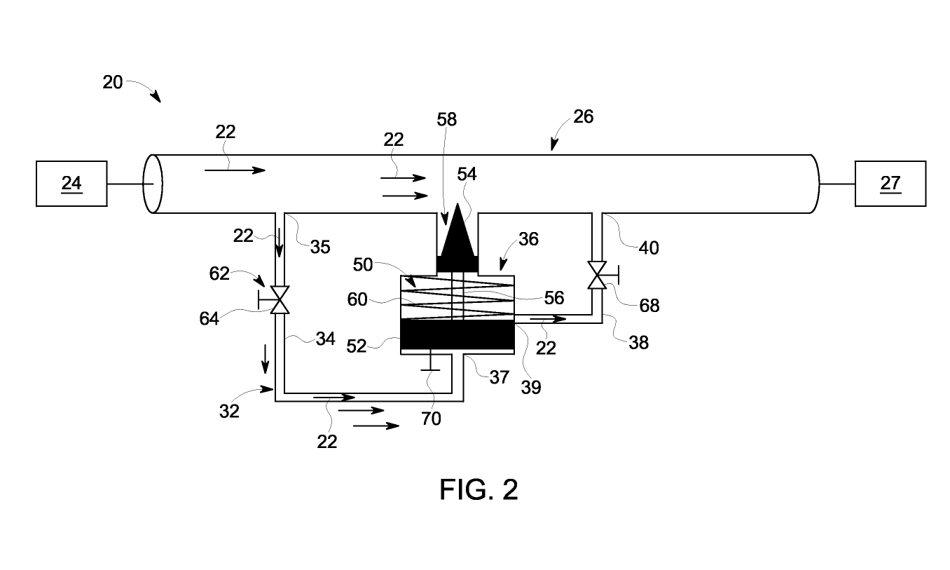

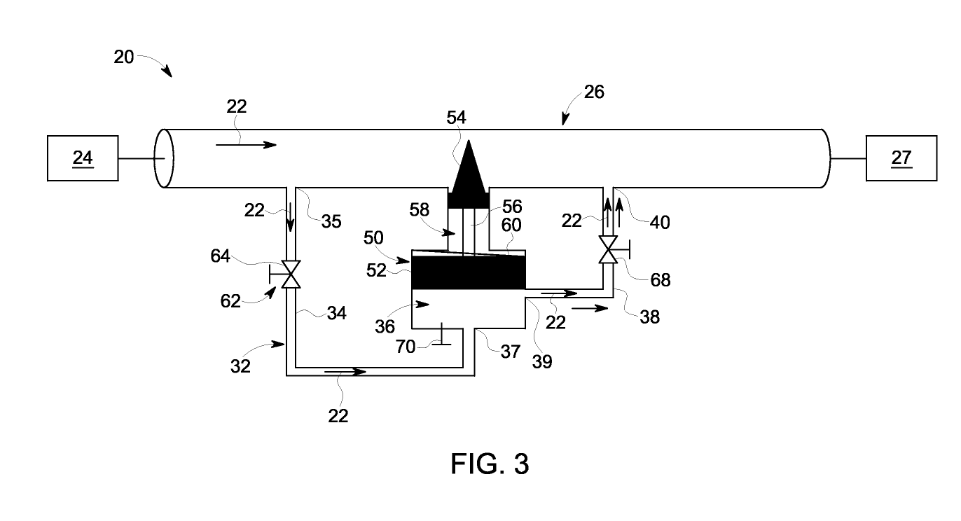

Referring now to FIGS. 2 and 3, the fuel supply system 20 configured to route the fuel 22 to the combustion assembly 14 is illustrated in greater detail. A fuel source 24, such as a fuel manifold, directs the fuel 22 from a supply (not illustrated) to a main fuel line path 26. The main fuel line path 26 extends between the fuel source 24 and the combustion assembly 14. In particular, the main fuel line path 26 provides a path for the fuel 22 to flow to a combustion inlet region 27 of the combustion assembly 14, such as a plenum and/or fuel injection nozzle. The main fuel line path 26 is formed of at least one pipe segment, but typically a plurality of pipe segments are operatively coupled to each other, such as in a welded manner.

A secondary fuel line path 32 is illustrated and is a secondary routing path for the fuel 22. As is the case with the main fuel line path 26 described above, the secondary fuel line path 32 is formed of at least one pipe segment, but typically a plurality of pipe segments are operatively coupled to each other, such as in a welded manner The secondary fuel line path 32 includes a first segment 34 extending between a main inlet 35 of the secondary fuel line path 32 to a fluid chamber 36, thereby branching the secondary fuel line path 32 directly off of the main fuel line path 26. In yet another embodiment, the first segment is located in a directly fluidly coupled configuration with the fuel source 24. Regardless of the precise location of the main inlet 35, it is configured to receive a portion of the fuel 22 that is supplied from the fuel manifold, thereby redirecting the portion of the fuel 22 to the secondary fuel line path 32 that would otherwise flow in an uninterrupted manner through the main fuel line path 26. The first segment 34 routes the fuel 22 to an inlet 37 of the fluid chamber 36.

A secondary fuel line path 32 also includes a second segment 38 extending between an outlet 39 of the fluid chamber 36 to a main outlet 40 of the secondary fuel line path 32, thereby providing a path to return the fuel 22 to the main fuel line path 26. It is contemplated that the main outlet 40 of the secondary fuel line path 32 is directly fluidly coupled with the combustion inlet region 27 to provide return of the fuel 22 to a location other than the main fuel line path 26. Regardless of the precise location of the main outlet 40, it is configured to return a portion of the fuel 22 that is supplied from the fuel source 24.

The fluid chamber 36 is configured to accumulate the fuel 22 passing through the secondary fuel line path 32. The pressure of the fuel 22 entering the fluid chamber 36 through the inlet 37 of the fluid chamber 36 is configured to interact with, and manipulate, an obstruction mechanism 50 disposed at least partially within the fluid chamber 36. The obstruction mechanism 50 includes a piston 52 that is located within the fluid chamber 36 and configured to translate between a first position (FIG. 2) and a second position (FIG. 3). In one embodiment, the piston 52 is of a circular cross-section and the fluid chamber 36 comprises a cylinder sized to accommodate the piston 52. The piston 52 is operatively coupled to an obstruction member 54, such as with a rod 56, for example. The obstruction member 54 extends at least partially within an orifice 58 that is adjacent the main fuel line path 26 in a manner that allows the obstruction member 54 to translate to various radial locations within the main fuel line path 26. In particular, as the piston 52 translates from the first position toward the second position, the obstruction member 54 is translated further into the main fuel line path 26, thereby reducing the cross-sectional area of the main fuel line path 26. It is contemplated that the obstruction member 54 is fully withdrawn from the main fuel line path 26 when the piston 52 is in the first position or may slightly protrude into the main fuel line path 26 when the piston 52 is in the first position.

The obstruction member 54 generically refers to a structure of any geometric configuration and formed of any suitable material for the operating conditions. It is to be appreciated that regardless of the precise configuration, the obstruction member 54 reduces the cross-sectional area for the fuel flow at the obstruction location as the obstruction member 54 is translated further into the main fuel line path 26.

In operation, as the pressure at the inlet 37 of the fluid chamber 36 increases, the piston 52 is forced away from the first position toward the second position, thereby translating the obstruction member 54 further into the main fuel line path 26. The cross-sectional area of the fluid chamber 36 is greater than a cross-sectional area of the orifice 58 that the obstruction member 54 is disposed within, thereby ensuring a greater force on the side of the piston 52 closest to the inlet 37 of the fluid chamber 36. A spring 60 is also included within the fluid chamber 36 and is configured to interact with the piston 52. Specifically, the spring 60 is compressed as the piston 52 moves from the first position to the second position, thereby opposing the force hydraulic force moving the piston 52. As shown, the spring force is not sufficient to overcome or fully resist the hydraulic force that moves the piston 52.

As shown in the second position of FIG. 3, the outlet 39 of the fluid chamber 36 is no longer blocked by the piston 52, thereby allowing fuel flow from the fluid chamber 36 to the second segment 38 of the secondary fuel line path 32. As this occurs, the pressure at the inlet of the fluid chamber 36 decreases rapidly as the fluid built up within the fluid chamber 36 exits. The reduction in pressure at the inlet 37 of the fluid chamber 36 decreases the force on the piston 52, thereby allowing the spring force imparted by the spring 60 on the piston 52 to overcome the hydraulic force and returning the piston 52 to the first position that is shown in FIG. 2. Over time, the process repeats itself and a cyclical translation of the piston 52, and hence the obstruction member 54, is achieved.

In another embodiment, an electromagnet is included and is configured to cycle between an energized condition and a non-energized condition in response to programmed time or fluid pressure of the fuel 22 at a location within the secondary fuel line path 32. This is done in a cyclical manner, as described above in relation to the previously described embodiments. It is to be appreciated that the cycling of the electromagnet may be entirely based on a time response oscillation frequency or entirely based on a fluid pressure detection of the fuel 22 within the fuel line path 32.

Various tuning components are included to control the speed of oscillation of the obstruction mechanism 50. Specifically, at least one valve 62, such as needle valves, is located within the secondary fuel line path 32. In one embodiment, the at least one valve 62 comprises a first valve 64 and a second valve 68, with the first valve 64 being located within the first segment 34 and the second valve 68 being located within the second segment 38 of the secondary fuel line path 32. As one can appreciate, more valves may be located within each of the segments. Additionally, an adjustment screw 70 or the like is operatively coupled to the fluid chamber 36. The adjustment screw 70 is moveable to define various locations of the first position of the piston 52. Further, the spring coefficient of the spring 60 and the cross-sectional area of the piston 52 may be modified to achieve desirable oscillation characteristics of the obstruction mechanism 50, as the adjustment screw 70 and the spring 60 are opposable in some embodiments.

By oscillating between the first position and the second position of the obstruction member 54, the secondary fuel line path 32 imposes mass flow fluctuations or oscillations within the main fuel line path 26 and therefore the combustion assembly 14, advantageously oscillating flow pressure of the combustion assembly 14. Such an assembly reduces or avoids the need for phase-matching avoidance techniques that are otherwise required.

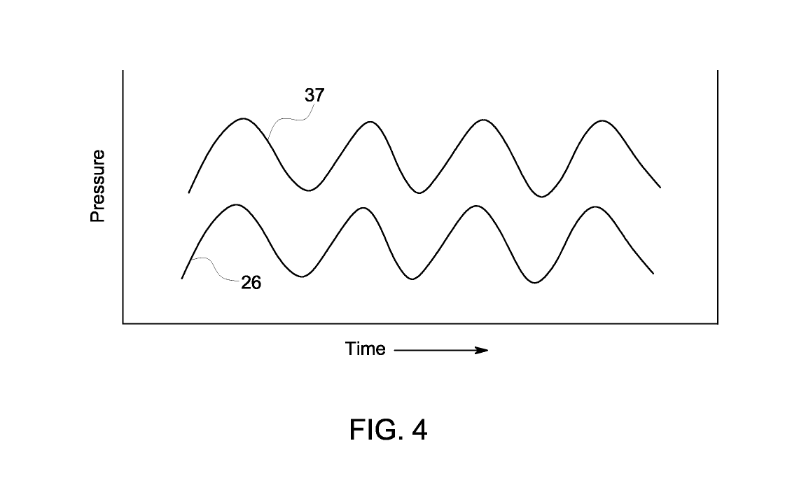

Referring to FIG. 4, an exemplary profile of the pressure at the inlet 37 of the fluid chamber 36 and the flow within the secondary fuel line path 32 is illustrated. As shown, the pressure and the mass flow oscillate in a cyclical manner as a function of time.

Advantageously, oscillation of the mass flow provides flexibility to design for higher power requirements without being concerned about frequency and/or phase matching.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A fuel supply system comprising:
a main fuel line path configured to route a fuel to a combustion inlet region;
a secondary fuel line path fluidly coupled to the main fuel line path and configured to divert a portion of the fuel from the main fuel line path through a first segment of the secondary fuel line path and return the fuel to the main fuel line path through a second segment of the secondary fuel line path; and
an obstruction mechanism located proximate the main fuel line path at an obstruction location, the obstruction mechanism configured to cyclically translate into the main fuel line path to cyclically alter a cross-sectional area of the main fuel line path.

2. The fuel supply system of claim 1, wherein the obstruction mechanism comprises:
a piston disposed within a fluid chamber of the secondary fuel line path; and
an obstruction member operatively coupled to the piston, the obstruction member configured to cyclically translate into the main fuel line path in response to translation of the piston between a first position and a second position.

3. The fuel supply system of claim 2, wherein translation of the piston from the first position to the second position occurs in response to a fluid pressure of the fuel at an inlet of the fluid chamber.

4. The fuel supply system of claim 3, wherein the obstruction mechanism further comprises a spring disposed within the fluid chamber, the spring configured to bias the piston toward the first position within the fluid chamber.

5. The fuel supply system of claim 2, further comprising an outlet of the fluid chamber configured to route the fuel from the fluid chamber to the second segment of the secondary fuel line path, wherein the outlet is blocked by the piston when the piston is in the first position.

6. The fuel supply system of claim 2, further comprising an outlet of the fluid chamber configured to route the fuel from the fluid chamber to the second segment of the secondary fuel line path, wherein the outlet is unblocked when the piston is in the second position.

7. The fuel supply system of claim 2, further comprising an adjustment screw operatively coupled to the fluid chamber and configured to selectively manipulate the first position, and a travel distance, of the piston.

8. The fuel supply system of claim 2, further comprising at least one valve within the secondary fuel line path.

9. The fuel supply system of claim 8, wherein the at least one valve comprises a needle valve.

10. The fuel supply system of claim 8, wherein the at least one valve comprises a first valve located within the first segment of the secondary fuel line path and a second valve located within the second segment of the secondary fuel line path.

11. The fuel supply system of claim 1, wherein the obstruction mechanism comprises an obstruction member and an electromagnet, the obstruction member configured to cyclically translate into the main fuel line path in response to an energized condition of the electromagnet.

12. A fuel supply system comprising:
a main fuel line path configured to route a fuel to a combustion inlet region;
a secondary fuel line path fluidly coupled to the main fuel line path, the secondary fuel line path having a fluid chamber, the fluid chamber having an inlet and an outlet;
a piston disposed within the fluid chamber and cyclically translatable between a first position and a second position;
an obstruction member disposed within an orifice extending between the fluid chamber and the main fuel line path, the obstruction member operatively coupled to the piston and moveable into the main fuel line path in response to translation of the piston, wherein the first position of the piston provides a first cross-sectional area of the main fuel line path and the second position of the piston provides a second cross-sectional area of the main fuel line path that is less than the first cross-sectional area;
a first segment of the secondary fuel line path routing fuel from the main fuel line path to the inlet of the fluid chamber; and
a second segment of the secondary fuel line path routing fuel from the outlet of the fluid chamber to the main fuel line path at a location downstream from the first segment.

13. The fuel supply system of claim 12, wherein translation of the piston from the first position to the second position occurs in response to a fluid pressure of the fuel at the inlet of the fluid chamber.

14. The fuel supply system of claim 12, further comprising a spring configured to bias the piston toward the first position with the fluid chamber.

15. The fuel supply system of claim 12, wherein a fluid chamber cross-sectional area is greater than an aperture cross-sectional area.

16. The fuel supply system of claim 12, wherein the outlet of the fluid chamber is blocked by the piston when the piston is in the first position.

17. The fuel supply system of claim 12, wherein the outlet of the fluid chamber is unblocked when the piston is in the second position.

18. The fuel supply system of claim 12, further comprising at least one valve within the secondary fuel line path.

19. The fuel supply system of claim 18, wherein the at least one valve comprises a first valve located within the first segment of the secondary fuel line path and a second valve located within the second segment of the secondary fuel line path.

20. A gas turbine system comprising:
a compressor;
a combustion assembly having at least one combustion chamber;
a turbine section; and
a fuel supply system configured to route fuel to the combustion assembly, the fuel supply system comprising:
a main fuel line path configured to route a fuel to a combustion inlet region;
a secondary fuel line path fluidly coupled to the main fuel line path and configured to divert a portion of the fuel from the main fuel line path through a first segment of the secondary fuel line path and return the fuel to the main fuel line path through a second segment of the secondary fuel line path; and
an obstruction mechanism located proximate the main fuel line path at an obstruction location, the obstruction mechanism configured to cyclically translate into the main fuel line path to cyclically alter a cross-sectional area of the main fuel line path.
